(19) United States
(12) Patent Application Publication
(10) Pub. No.: US 2011/0023648 A1
(43) Pub. Date: Feb. 3, 2011

(54) SHIFTING MECHANISM FOR DOUBLE CLUTCH TRANSMISSION

(75) Inventors: Jongyop Kim, Seoul (KR); Sungyong Cho, Hwaseong-si (KR); Hyunduk Chang, Suwon-si (KR)

Correspondence Address: MORGAN, LEWIS & BOCKIUS LLP (SF), One Market, Spear Street Tower, Suite 2800, San Francisco, CA, 94105, US

(73) Assignee: HYUNDAI MOTOR COMPANY, Seoul (KR)

(21) Appl. No.: 12/618,383

(22) Filed: Nov. 13, 2009

(30) Foreign Application Priority Data
Jul. 28, 2009 (KR) 10-2009-0068798

(51) Int. Cl. F16H 63/30

(52) U.S. Cl. 74/473.36

(57) ABSTRACT

A shift mechanism for a double clutch transmission is provided with a pre-select function that selects any one of a plurality of shift stages of the double clutch transmission and then selects a shift stage in another shift line and an interlock prevention function that prevents shift stages in one shift line from being selected, and allows for quick shift.

### CROSS-REFERENCE TO RELATED APPLICATION

The present application claims priority of Korean Patent Application Number 10-2009-0068798 filed Jul. 28, 2009, the entire contents of which application is incorporated herein for all purposes by this reference.

### BACKGROUND OF THE INVENTION

1. Field of the Invention

The present invention relates to a shifting device for a double clutch transmission, particularly mechanism that makes it possible to shift by selectively engaging a plurality of shift gears.

2. Description of Related Art

Double clutch transmissions, different from a single clutch transmission systems of the related art, are shifting systems equipped with two clutches and designed to form separate shifting lines while one clutch connects/disconnects the gears of the odd-numbered stages and the other clutch connects/disconnects the gears of the even-numbered stages, which facilitate driving, such as automatic transmission, and achieve large improvement of fuel efficiency and direct response, such as manual transmissions.

Further, double clutch transmissions allow for smooth shifting, because disconnection of acceleration, which is generated in transmissions equipped with a single clutch, does not occur.

The double clutch transmissions should be provided with a pre-select function that engages in advance a shift gear of a shift stage in a next desired shift line other than the present shift stage, in order to shift only by changing the operation of the two clutches.

Further, since shift stages in one shift line should not be selected at the same time, an interlock prevention function should be provided to prevent the above situation.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide shift mechanism for a double clutch transmission which is provided with a pre-select function that selects any one of a plurality of shift stages of the double clutch transmission and then selects a shift stage in another shift line and an interlock prevention function that prevents shift stages in one shift line from being selected, and allows for quick shift.

An aspect of the present invention provides a shifting mechanism for a double clutch transmission that divides a plurality of shift stages having different gear ratios into integer number of continuous shift stages in accordance with the order of the gear ratios, which includes: a plurality of odd-numbered stage driven-shift elements that makes engagement and disengagement at odd-numbered shift stages by straight strokes; a plurality of even-numbered stage driven-shift elements that makes engagement and disengagement at the even-numbered shift stages by straight strokes; an odd-numbered stage driving-shift elements that is provided to selectively move straight any one of the odd-numbered stage driven-shift elements by straight motion path perpendicularly crossing each other; and an even-numbered stage driving-shift element that is provided to selectively move straight any one of the even-numbered stage driven-shift elements by straight motion path perpendicularly crossing each other.

The present invention is provided with a pre-select function that selects any one of a plurality of shift stages of the double clutch transmission and then selects a shift stage in another shift line and an interlock prevention function that prevents shift stages in one shift line from being selected, and allows for quick shift.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a view illustrating a shifting mechanism of the present invention in the neutral position.

FIG. 2 is a view illustrating a pre-selected state in the shifting mechanism of FIG. 1.

FIG. 3 is a view illustrating another shifting mechanism of the present invention in a neutral position.

FIG. 4 is a view illustrating a pre-selected state in the shifting mechanism of FIG. 3.

FIG. 5 is a view illustrating a shifting mechanism similar to that of FIG. 1, in which an odd-numbered stage driving-shift element and an even-numbered stage driving-shift element are each composed of a rotary shaft and a protrusion.

FIG. 6 is a view illustrating a shifting mechanism similar to that of FIG. 3, in which an odd-numbered stage driving-shift element and an even-numbered stage driving-shift element are each composed of a rotary shaft and a protrusion.

FIG. 7 is a view illustrating actuation of the rotary shaft and the protrusion applied to the shifting mechanisms of FIGS. 5 and 6.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

A shifting device of a double clutch transmission according to an various embodiments of the present invention divides a plurality of shift stages having different gear ratios into integer number of continuous shift stages in accordance with the order of the gear ratios.

That is, a plurality of shift stages that can be achieved in the double clutch transmission is divided into continuous integer number of shift stages composed of first shift stage to N-th shift stage in the order of gear ratio, odd-numbered stages and even-numbered stages which are described below are divided on the basis of the order.

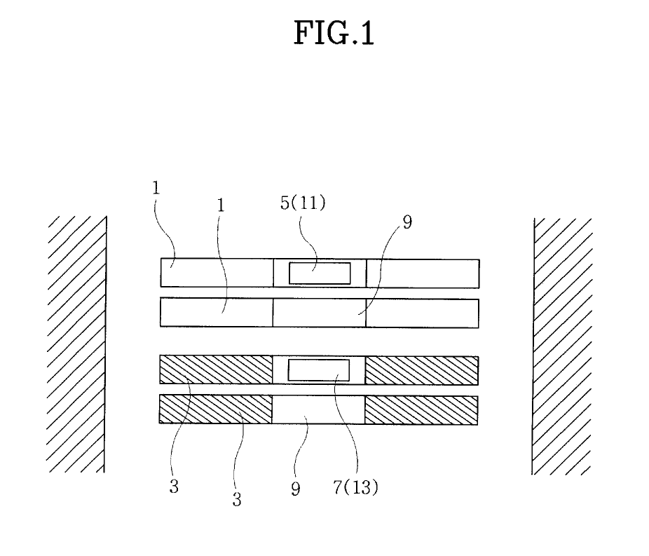

Referring to FIGS. 1 to 4, various embodiments of the present invention may include a plurality of odd-numbered stage driven-shift elements 1 that makes engagement and disengagement at the odd-numbered shift stages by straight strokes, a plurality of even-numbered stage driven-shift elements 3 that makes engagement and disengagement at the even-numbered shift stages by straight strokes, an odd-numbered stage driving-shift elements 5 that is provided to selectively move straight any one of odd-numbered stage driven-shift elements 1 by straight motion path perpendicularly crossing each other, and/or an even-numbered stage driving-shift element 7 that is provided to selectively move straight any one of even-numbered stage driven-shift elements 3 by straight motion path perpendicularly crossing each other, all encased within a transmission housing.

In various embodiments, odd-numbered stage driven-shift elements 1 are disposed to make engagement and disengagement in the corresponding shift stages by parallel straight strokes and even-numbered stage driven-shift elements 3 are disposed to make engagement and disengagement in the corresponding shift stages by parallel straight strokes independently from odd-numbered stage driven-shift elements 1, in which even-numbered stage driving-shift element 7 operates independently from odd-numbered stage driving-shift elements 5.

That is, various embodiments of the present invention are configured such that odd-numbered stage driven-shift elements 1 and even-numbered stage driven-shift elements 3 are independently operated by odd-numbered stage driving-shift elements 5 and even-numbered stage driving-shift element 7.

Since, as described above, odd-numbered stage driving-shift elements 5 and even-numbered stage driving-shift element 7 are independently operated, it is possible to achieve a pre-select function that makes it possible to engage any one shift stage and simultaneously engage in advance a shift stage in another shift line.

In this configuration, odd-numbered stage driven-shift elements 1 and odd-numbered stage driving-shift elements 5 form one shift line together with one of two clutches of the double clutch transmission, and even-numbered stage driven-shift elements 3 and even-numbered stage driving-shift element 7 form another shift line together with the other clutch.

Odd-numbered stage driven-shift element 1 has a receiving groove 9 where odd-numbered stage driving-shift element 5 is inserted to supply straight motion force in two opposite directions and odd-numbered stage driving-shift element 5 has an odd-numbered stage driving protrusion 11 that is inserted in receiving groove 9 to prevent relative motion of odd-numbered stage driven-shift elements 1 in the straight motion directions.

Even-numbered stage driven-shift element 3 has a receiving groove 9 where even-numbered stage driving-shift element 7 is inserted to supply straight motion force in two opposite directions and even-numbered stage driving-shift element 7 has an even-numbered stage driving protrusion 13 that is inserted in receiving groove 9 to prevent relative motion of even-numbered stage driven-shift elements 3 in the straight motion directions.

That is, odd-numbered stage driven-shift elements 1 and even-numbered stage driven-shift elements 3 each have receiving groove 9, odd-numbered stage driving protrusion 11 is selectively inserted into any one of receiving grooves 9 formed in odd-numbered stage driven-shift elements 1 and the moves straight, thereby engaging the selective shift stage, and even-numbered stage driving protrusion 13 is selectively inserted into any one of receiving grooves 9 formed in even-numbered stage driven-shift elements 3, independent from odd-numbered stage driving protrusion 11, and then moves straight, thereby engaging the selected shift stage.

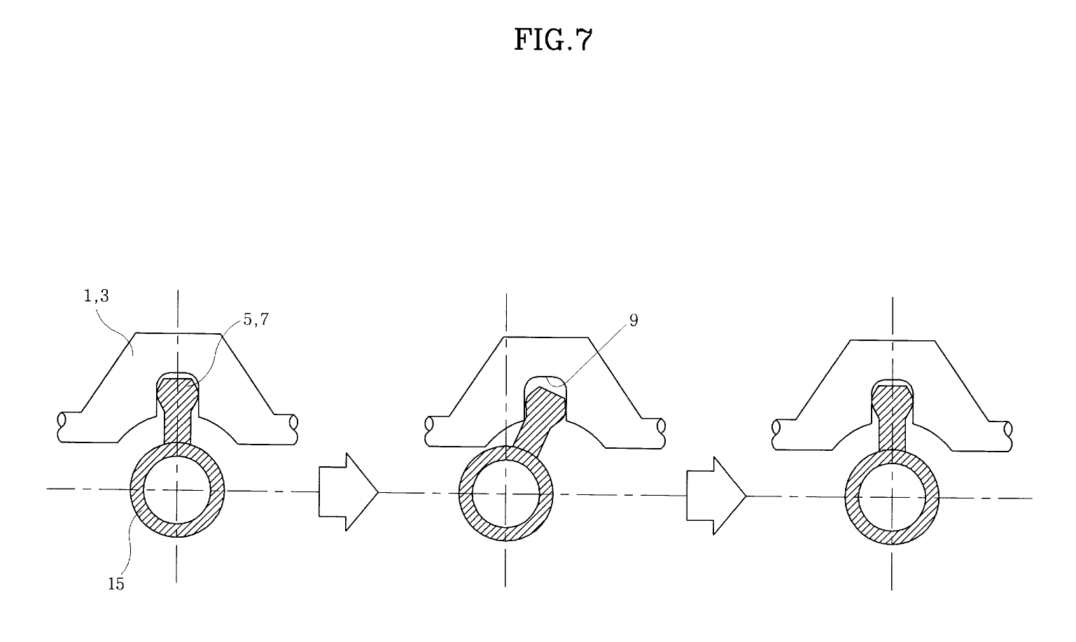

In particular, as can be seen from FIG. 7, odd-numbered stage driving protrusion 11 is formed the same in width as receiving grooves 9 of odd-numbered stage driven-shift elements 1 without making relative motion therebetween in the straight motion directions of odd-numbered stage driven-shift elements 1, such that the straight motion of odd-numbered stage driving protrusion 11 is immediately converted into straight stroke of odd-numbered stage driven-shift elements 1, thereby ensuring quick shift, and this operation is achieved between odd-numbered stage driving protrusion 13 and receiving grooves 9 of even-numbered stage driven-shift elements 3.

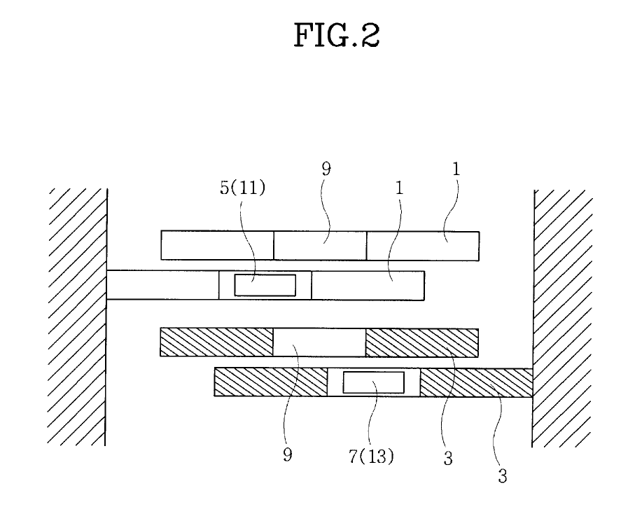

With reference to FIGS. 1 and 2, odd-numbered stage driven-shift elements 1 are disposed such that receiving grooves 9 are arranged in a line in the neutral position and even-numbered stage driven-shift elements 3 are disposed such that receiving grooves 9 are arranged in a line in the same straight line as receiving grooves 9 of odd-numbered stage driven-shift elements 1 in the neutral position.

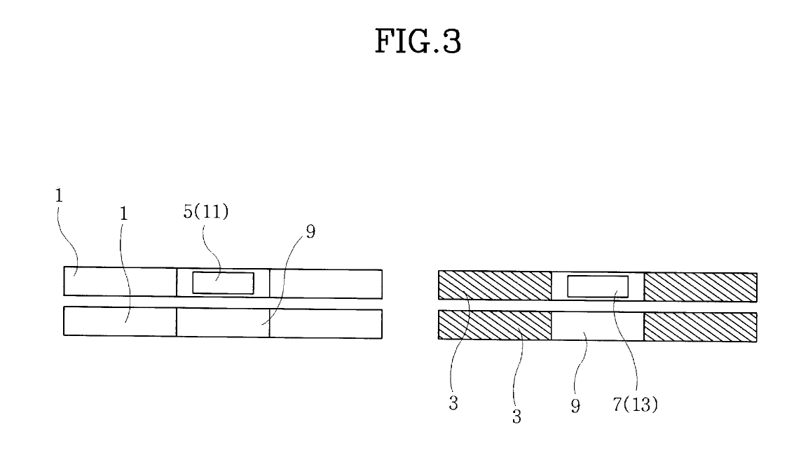

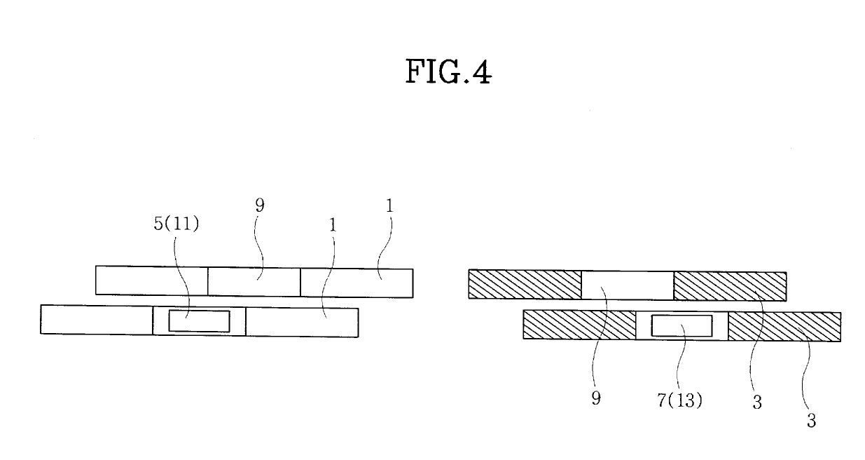

With reference to FIGS. 3 and 4, odd-numbered stage driven-shift elements 1 are disposed such that receiving grooves 9 are arranged in a line in the neutral position and even-numbered stage driven-shift elements 3 are disposed such that receiving grooves 9 are arranged in a line in the neutral position, independently from receiving grooves 9 of odd-numbered stage driven-shift elements 1.

In particular, even-numbered stage driven-shift elements 3 are disposed apart at one side in the straight motion directions of odd-numbered stage driven-shift elements 1 to form straight strokes being in parallel with the straight motion directions of odd-numbered stage driven-shift elements 1.

In various embodiments, it is common that odd-numbered stage driven-shift elements 1 are disposed such that receiving grooves 9 are arranged in a line in the neutral position and even-numbered stage driven-shift elements 3 are disposed such that receiving grooves 9 are arranged in a line, and these structural characteristics allow for the interlock prevention function by preventing shift stages from being engaged at the same time in one shift line, with the insertion structure without motion between odd-numbered stage driving protrusion 11 and receiving grooves 9 of odd-numbered stage driven-shift elements 1 and the insertion structure without motion between even-numbered stage driving protrusion 13 and receiving grooves 9 of even-numbered stage driven-shift elements 3.

That is, exemplifying the shift line of the odd-numbered stage, since odd-numbered stage driven-shift elements 1 are disposed such that receiving grooves 9 are arranged in a line in the neutral position, when odd-numbered stage driving protrusion 11 is inserted in any one of receiving grooves 9 and then moves straight, odd-numbered stage driving protrusion 11 cannot be inserted into receiving grooves 9 of other odd-numbered stage driven-shift elements 1, such that interlock is prevented in the structure.

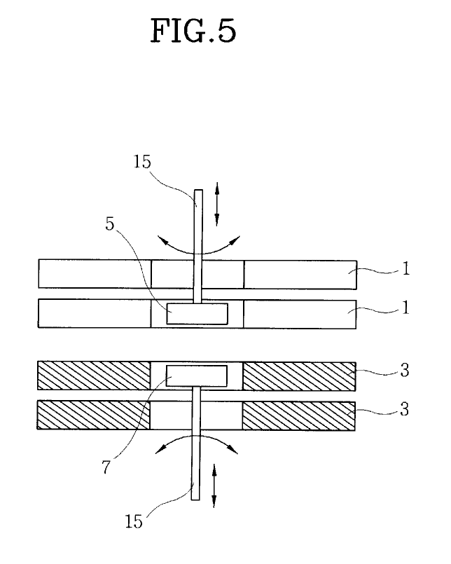

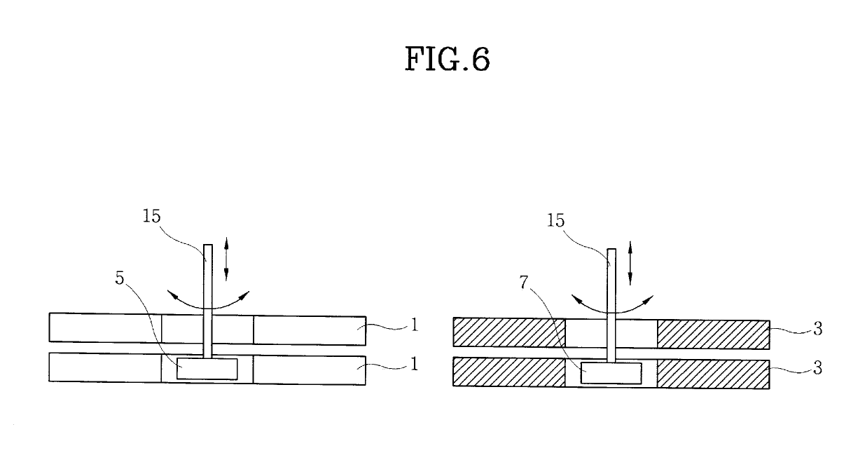

On the other hand, as shown in FIGS. 5 and 6, odd-numbered stage driving protrusion 11 is composed of rotary shaft 15 and a protrusion that protrudes from rotary shaft 15, such that odd-numbered stage driving-shift element 5 can be configured to perform a selecting operation of selecting one of odd-numbered stage driven-shift elements 1 by axial movement of rotary shaft 15 and then implements a shifting operation by making straight stroke of odd-numbered stage driven-shift elements 1 by rotary motion of the protrusion which is generated by rotation of rotary shaft 15, which is the same as in even-numbered stage driving-shift element 7.

Although the protrusion makes rotary motion by itself, as a result, the rotary motion is applied as straight motion to odd-numbered stage driven-shift elements 1 or even-numbered stage driven-shift elements 3.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A shifting mechanism for a double clutch transmission that divides a plurality of shift stages having different gear ratios into integer number of continuous shift stages in accordance with the order of the gear ratios, the mechanism comprising:
a plurality of odd-numbered stage driven-shift elements that engage and disengage at odd-numbered shift stages by straight strokes;
a plurality of even-numbered stage driven-shift elements that engage and disengage at the even-numbered shift stages by straight strokes;
an odd-numbered stage driving-shift elements that selectively move straight any one of the odd-numbered stage driven-shift elements by straight motion path perpendicularly crossing each other; and
an even-numbered stage driving-shift element that selectively move straight any one of the even-numbered stage driven-shift elements by straight motion path perpendicularly crossing each other.

2. The shifting mechanism for a double clutch transmission as defined in claim 1, wherein the odd-numbered stage driven-shift elements are disposed to engage and disengage in the corresponding shift stages by parallel straight strokes,
the even-numbered stage driven-shift elements are disposed to engage and disengage in the corresponding shift stages by parallel straight strokes independently from the odd-numbered stage driven-shift elements, and
the even-numbered stage driving-shift element operates independently from the odd-numbered stage driving-shift elements.

3. The shifting mechanism for a double clutch transmission as defined in claim 2, wherein each of the odd-numbered stage driven-shift element has a receiving groove where the odd-numbered stage driving-shift element is inserted to supply straight motion force in two opposite directions,
the odd-numbered stage driving-shift element has an odd-numbered stage driving protrusion that is inserted in the receiving groove to prevent relative motion of the odd-numbered stage driven-shift elements in the straight motion directions,
each of the even-numbered stage driven-shift element has a receiving groove where the even-numbered stage driving-shift element is inserted to supply straight motion force in two opposite directions, and
the even-numbered stage driving-shift element has an even-numbered stage driving protrusion that is inserted in the receiving groove to prevent relative motion of the even-numbered stage driven-shift elements in the straight motion directions.

4. The shifting mechanism for a double clutch transmission as defined in claim 3, wherein the odd-numbered stage driven-shift elements are disposed such that the receiving grooves are arranged in a line in the neutral position, and
the even-numbered stage driven-shift elements are disposed such that the receiving grooves are arranged in a line in the same straight line as the receiving grooves of the odd-numbered stage driven-shift elements in the neutral position.

5. The shifting mechanism for a double clutch transmission as defined in claim 3, wherein the odd-numbered stage driven-shift elements are disposed such that the receiving grooves are arranged in a line in the neutral position, and
the even-numbered stage driven-shift elements are disposed such that the receiving grooves are arranged in a line in the neutral position, independently from the receiving grooves of the odd-numbered stage driven-shift elements.

6. The shifting mechanism for a double clutch transmission as defined in claim 5, wherein the even-numbered stage driven-shift elements are disposed apart at one side in straight motion directions of the odd-numbered stage driven-shift elements to form straight strokes being in parallel with the straight motion directions of the odd-numbered stage driven-shift elements.

7. A double clutch transmission comprising the shifting mechanism of claim 1, and further comprising a transmission housing encasing the shifting mechanism.
